(19) United States
(12) Patent Application Publication
(10) Pub. No.: US 2004/0002018 A1
(43) Pub. Date: Jan. 1, 2004

(54) Manufacturing method of optical disc and optical disc thereby

(76) Inventors: Kenji Oishi, Yokohama-shi (JP); Osamu Akutsu, Fujisawa-shi (JP); Katsunori Ohshima, Kamakura-shi (JP)

Correspondence Address: CONNOLLY BOVE LODGE & HUTZ LLP, SUITE 800, 1990 M STREET NW, WASHINGTON, DC, 20036-3425, US

(21) Appl. No.: 10/390,913

(22) Filed: Mar. 19, 2003

(30) Foreign Application Priority Data
Mar. 20, 2002 (JP) 2002-077959
Dec. 19, 2002 (JP) 2002-367751

(51) Int. Cl. G11B 7/24; B44C 1/00; B32B 31/00; C09J 1/00

(52) U.S. Cl. 430/270.13; 369/283; 369/288; 156/237; 156/273.3; 156/289

(57) ABSTRACT

A manufacturing method of an optical disc 16 is composed of a first process of forming at least a first recording layer 5 over a first embossed pit 2 of a first substrate 1, a second process of forming at least a separative layer 9 and a second recording layer 11 sequentially over a second embossed pit 8 of a second substrate 7 having light transmittability, a third process of laminating the second substrate 7 over the first substrate 1 after coating an ultraviolet curable resin 14 over the first recording layer 5 and facing the second recording layer 11 toward the ultraviolet curable resin 14, and hardening the ultraviolet curable resin 14 by irradiating an ultraviolet ray on the ultraviolet curable resin 14 through the second substrate 7, a fourth process of transferring the second recording layer 11 over the first recording layer 5 by separating the second substrate 7 from the first substrate 1 together with the separative layer 9, and a fifth process of forming a thin cover layer 15 having light transmittability over the second recording layer 11.

### BACKGROUND OF THE INVENTION

1. Field of the Invention

The present invention relates to a manufacturing method of optical disc and an optical disc thereby, particularly, relates to a manufacturing method of optical disc having more than two recording layers, which can be recorded and reproduced, and an optical disc thereby.

2. Description of the Related Art

Currently, an optical disc in higher recording density, which is capable of recording and reproducing large capacity has been developed so as to comply with the multimedia era in which a large amount of information is handled. It is required for a laser beam utilized for recording and reproducing such an optical disc that a spot diameter of the laser beam shall be minimized.

Consequently, it has been tried to shorten a wavelength of laser beam or to increase a numerical aperture of objective lens. In the case of a wavelength of laser beam utilized for a blu-ray disc, for example, the wavelength is within a range of 400 nm to 420 nm that is shorter than the wavelength range of 635 nm to 660 nm, which is utilized for DVD-RW discs and DVD-ROM discs.

In the case of a numerical aperture of objective lens utilized for a blu-ray disc, the numerical aperture is 0.85 that is larger than the numerical aperture of 0.6 utilized for DVD-RW discs and DVD-ROM discs.

In order to comply with such a demand, the Japanese Patent Laid-open Publication No. 9-063120/1997 discloses an optical disc having one information layer or a recording layer. The optical disc is formed with an embossed pit on a first substrate through the injection molding process.

Further, a reflective layer and a transparent film having a thickness of 0.1 mm is formed on the embossed pit in order. The optical disc is irradiated by a laser beam from the transparent film side.

Furthermore, in order to increase recording density, the Japanese Patent Laid-open Publication No. 9-063120/1997 also discloses a manufacturing method of an optical disc having two information read-out layers. The optical disc is composed of a first substrate having a first embossed pit and a reflective layer formed on the first embossed pit while a semi-transmittable film is formed on a light transmittable second substrate having a second embossed pit. The reflective layer is displaced with facing toward the semi-transmittable film with sandwiching light curable resin between them, and then they are laminated by irradiating ultraviolet rays through the second substrate. Finally, the optical disc having two information read-out layers is manufactured.

In the case of manufacturing a blu-ray disc by using the manufacturing method of optical disc disclosed in the Japanese Patent Laid-open Publication No. 9-063120/1997, a thickness of the first substrate must be thinned as thin as the order of 0.1 mm in order to suppress aberration caused by the thickness of the second substrate. However, it is hard to form a guide groove or an embossed pit on such a thin substrate. In addition thereto, there is existed a problem such that heating during manufacturing process when forming a plurality of thin film layers on the thin second substrate results in warping the second substrate totally.

In other words, in the case that a guide groove and a embossed pit is formed by using a stamper through the injection molding process as the same manufacturing method as manufacturing DVD discs, the thin second substrate may warp due to added heat or is hardly separated from a molding die and resulted in deforming the guide groove and the embossed pit. Consequently, it is difficult to transfer the guide groove and the embossed pit on the stamper to the thin second substrate accurately.

Further, a thin substrate having a thickness of 0.1 mm lacks of stiffness, so that works in a transporting process and a separating process are complicated. As mentioned above, a blu-ray disc is hardly manufactured by the same manufacturing method as manufacturing conventional DVD discs.

With respect to countermeasure for the problem, developing a manufacturing process exclusively for a blu-ray disc is considered. However, it increases a manufacturing cost. If the conventional manufacturing method of a DVD disc is utilized for manufacturing a blu-ray disc, a blu-ray disc can be manufactured in less expensive cost.

### SUMMARY OF THE INVENTION

Accordingly, in consideration of the above-mentioned problems of the prior arts, an object of the present invention is to provide a manufacturing method of optical disc for blu-ray, which can adopt the same manufacturing processes as manufacturing a conventional DVD disc and can manufacture a blu-ray disc in less expense manufacturing cost, and an optical disc thereby.

In order to achieve the above object, the present invention provides, according to an aspect thereof, a manufacturing method of an optical disc comprising: a first process of forming at least a first recording layer over a first embossed pit of a first substrate; a second process of forming at least a separative layer and a second recording layer sequentially over a second embossed pit of a second substrate having light transmittability; a third process of laminating the second substrate over the first substrate after coating an ultraviolet curable resin over the first recording layer and facing the second recording layer toward the ultraviolet curable resin, and hardening the ultraviolet curable resin by irradiating an ultraviolet ray on the ultraviolet curable resin through the second substrate; a fourth process of transferring the second recording layer over the first recording layer by separating the second substrate from the first substrate together with the separative layer; and a fifth process of forming a thin cover layer having light transmittability over the second recording layer.

According to another aspect of the present invention, there provided a manufacturing method of an optical disc comprising: a first process of initializing a first recording layer after forming at least the first recording layer over a first embossed pit of a first substrate; a second process of initializing a second recording layer after forming at least a separative layer and the second recording layer sequentially over a second embossed pit of a second substrate having light transmittability; a third process of laminating the second substrate over the first substrate after coating an ultraviolet curable resin over the first recording layer and facing the second recording layer toward the ultraviolet curable resin, and hardening the ultraviolet curable resin by irradiating an ultraviolet ray on the ultraviolet curable resin through the second substrate; a fourth process of transferring the second recording layer over the first recording layer by separating the second substrate from the first substrate together with the separative layer; and a fifth process of forming a thin cover layer having light transmittability over the second recording layer.

According to a further aspect of the present invention, there provided an optical disc comprising: a first substrate having a first embossed pit being formed with at least a first recording layer over the first embossed pit; a second substrate having a second embossed pit being formed with at least a separative layer and a second recording layer sequentially laminated over the second embossed pit, and an ultraviolet curable resin layer coated over the first recording layer and being sandwiched between the first and second substrates and cured by irradiating an ultraviolet ray, wherein the second reflective layer is faced toward the ultraviolet curable resin layer, the optical disc is further characterized in that the second substrate is separated from the first substrate together with the separative layer, and that a thin cover layer having light transmittability is formed over the second recording layer.

Other object and further features of the present invention will be apparent from the following detailed description when read in conjunction with the accompanying drawing.

### BRIEF DESCRIPTION OF DRAWINGS

FIG. 1 is a cross sectional view of an optical disc showing a process of forming a first recording layer in a manufacturing method according to an embodiment of the present invention.

FIG. 2 is a cross sectional view of the optical disc showing a process of forming a second recording layer in the manufacturing method according to the embodiment of the present invention.

FIG. 3 is a cross sectional view of the optical disc showing a laminating process in the manufacturing method according to the embodiment of the present invention.

FIG. 4 is a cross sectional view of the optical disc showing a transferring process in the manufacturing method according to the embodiment of the present invention.

FIG. 5 is a cross sectional view of the optical disc as a final product showing a process of forming a cover layer in the manufacturing method according to the embodiment of the present invention.

### DETAILED DESCRIPTION OF THE PREFERRED EMBODIMENTS

[Process of Forming First Recording Layer]

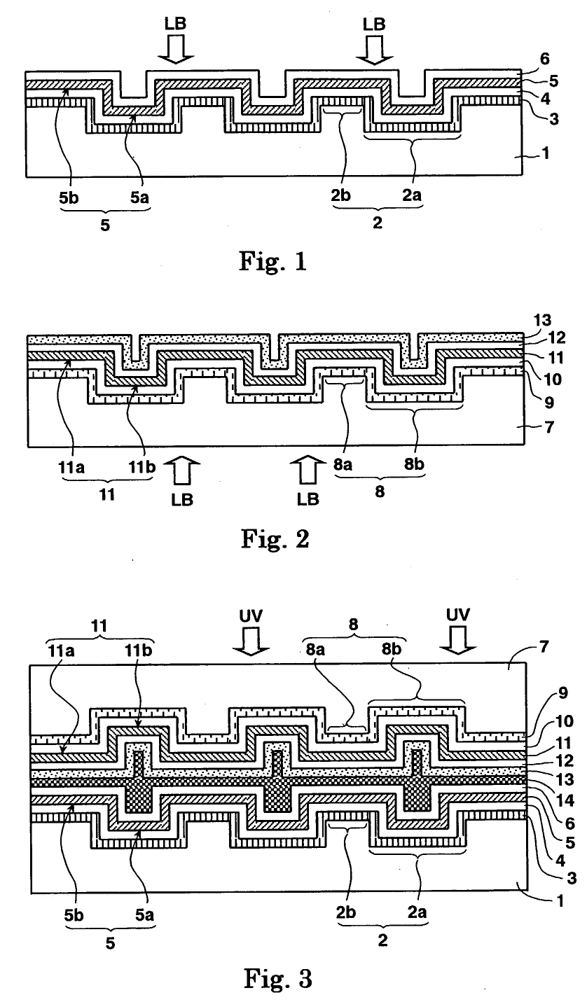

FIG. 1 is a cross sectional view of an optical disc showing a process of forming a first recording layer in a manufacturing method according to an embodiment of the present invention.

As shown in FIG. 1, a first reflective layer 3, a first protective layer 4, a first recording layer 5 and a second protective layer 6 is formed over a first embossed pit 2 of a first substrate 1 sequentially. Then the first recording layer 5 is initialized by irradiating a laser beam LB from the second protective layer 6 side.

In this process, a thickness of the first substrate 1 is within a range of 0.3 mm to 1.2 mm. With respect to a material of the first substrate 1, such a resin as polycarbonate, polyolefin or acrylic resin and glass can be used. The first substrate 1 is produced by the injection molding method or the photo-polymer (2P) method. The first embossed pit 2 is formed as a guide groove for a laser beam when recording on or reproducing from a pre-groove or a pre-pit and composed of a recessed portion 2a and a raised portion 2b.

Further, a depth of the recessed portion 2a is 30 nm, for example, and a width of the recessed portion 2a and the raised portion 2b is 0.15 μm and 0.17 μm respectively.

With respect to a material for the first reflective layer 3, a metal such as Al, Au, Ag, Cu, Ni, In, Ti, Cr, Pt and Si, an alloy alloying with some of them, or a semiconductor can be used. A thickness of the first reflective layer 3 is within a range of 5 nm to 200 nm.

With respect to a material for the protective layers 4 and 6, such a metal compound as oxide, nitride, sulfide, or carbide can be used. For example, a simple substance such as ZnS—SiO₂, ZnS, SiO₂, Ta₂O₅, Si₃N₄, AlN, Al₂O₃, AlSiON, ZrO₂, TiO₂, and SiC or mixture of them can be used for the material of the protective layers 4 and 6. Each of the first and second protective layers 4 and 6 has a refractive index of 1.8 to 2.5 and an extinction coefficient of zero to 0.2.

Further, a thickness of the first and second protective layers 4 and 6 is 5 nm to 50 nm and 10 nm to 150 nm respectively.

With respect to a material of the first recording layer 5, a phase change material utilizing reflectivity change or refractive index change between amorphous and crystal is used. Actually, such a material as Ge—Sb—Te system, Ag—In—Te—Sb system, Cu—Al—Sb—Te system, or Sb—Te system can be used.

Further, a thickness of the first recording layer 5 is preferable to be within a range of 10 nm to 100 nm. However, in order to improve recording sensitivity by increasing a reproduced signal when reproducing, it is desirable to be within a range of 5 nm to 30 nm.

With respect to initialization, irradiating a laser beam having a spot diameter that is larger than a track width of the first substrate 1 on the first recording layer 5 heats the first recording layer 5 up to a crystallizing temperature, and a plurality of tracks is initialized simultaneously. Light of a flush lamp other than a laser beam can be used for the initialization.

In the first recording layer 5 hereupon, a groove 5a and a land 5b is formed to comply with the recessed portion 2a and the raised portion 2b of the first embossed pit 2 respectively.

[Process of Forming Second Recording Layer]

FIG. 2 is a cross sectional view of the optical disc showing a process of forming a second recording layer in the manufacturing method according to the embodiment of the present invention.

As shown in FIG. 2, a separative layer 9, a third protective layer 10, a second recording layer 11, a fourth protective layer 12 and a second reflective layer 13 is formed over a second embossed pit 8 of a second substrate 7 having light transmittability sequentially. Then the second recording layer 11 is initialized by irradiating a laser beam LB from the second substrate 7 side. Actual initialization is the same as that of the first recording layer 5 mentioned above.

A pitch of the second embossed pit 8 is the same as that of the first embossed pit 2. The second embossed pit 8 is also composed of a recessed portion 8a and a raised portion 8b and their shapes are the same as those of the first embossed pit 2.

The separative layer 9 is formed through the vacuum evaporation process by resistor heating or electron beam, the direct current or alternative current sputtering process, the reactive sputtering process, the ion beam sputtering process, or the ion plating process. With respect to a material of the separative layer 9, an organic material such as guanine, adenine, xanthone, pyrene, polyethylene, stilbene, triphenyl methane, azo di-carbon amide, PMMA (poly-methyl methacrylate), oxybis (benzene sulfonyl hydrazide), bisphenol A, stearic acid amide, Mn phthalocyanine, thymine, and anthraquinone or inorganic metal such as Au, Ag, Cu, and Pt can be used for the material of the separative layer 9.

With respect to materials for the third and fourth protective layers 10 and 12, such a metal compound as oxide, nitride, sulfide, carbide, or mixture of them can be used. For example, a simple substance such as ZnS—SiO₂, ZnS, SiO₂, Ta₂O₅, Si₃N₄, AlN, Al₂O₃, AlSiON, ZrO₂, TiO₂, and SiC or mixture of them can be used for the material of the third and fourth protective layers 10 and 12. Each of the third and fourth protective layers 10 and 12 has a refractive index of 1.8 to 2.5 and an extinction coefficient of zero to 0.2.

Further, thicknesses of the third protective layer 10 is preferable to be within a range of 10 nm to 200 nm. However, in order to increase a reproduction signal when reproducing, it is more desirable to be within a range of 10 nm to 150 nm. A thickness of the fourth protective layer 12 is desirable to be within a range of 1 nm to 50 nm.

With respect to a material of the second recording layer 11, a phase change material utilizing reflectivity change or refractive index change between amorphous and crystal is used. Actually, such a material as Ge—Sb—Te system, Ag—In—Te—Sb system, Cu—Al—Sb—Te system, or Sb—Te system can be used.

Further, a thickness of the second recording layer 11 is within a range of 2 nm to 100 nm. However, in order to improve recording sensitivity by increasing a reproduced signal when reproducing, it is desirable to be within a range of 2 nm to 10 nm.

In the second recording layer 11 hereupon, a groove 11a and a land 11b is formed to comply with the recessed portion 8a and the raised portion 8b of the second embossed pit 8 respectively.

The second reflective layer 13 is essential to transmit a laser beam and conduct the laser beam to the first recording layer 5. Therefore, the second reflective layer 13 is essential to be prepared for light transmittability together with reflectiveness.

Further, in order to radiate heat that is generated by light being absorbed by the second recording layer 11 effectively, the second reflective layer 13 is also essential to be high in heat conductivity. With respect to a material satisfying those requirements, a metal such as Al, Au, Ag, Cu, Ni, In, Ti, Cr, Pt, and Si, an alloy alloying with some metals of them or a semiconductor is suitable for the second reflective layer 13.

Furthermore, a thickness of the second reflective layer 13 is preferable to be within a range of 2 nm to 100 nm. However, in order to satisfy both the reflectivity and light transmittability, it is more preferable to be within a range of 2 nm to 10 nm.

[Laminating Process]

FIG. 3 is a cross sectional view of the optical disc showing a laminating process in the manufacturing method according to the embodiment of the present invention.

As shown in FIG. 3, an ultraviolet curable resin 14 is coated on the surface of the second protective layer 6, and then the second substrate 7 is laminated on the first substrate 1 such that the second reflective layer 13 faces toward the ultraviolet curable resin 14. Then, the ultraviolet curable resin 14 is hardened by irradiating an ultraviolet ray UV on the ultraviolet curable resin 14 through the second substrate 7. Consequently, the second substrate 7 is laminated over the first substrate 1.

With respect to a coating method of the ultraviolet resin 14, there is existed several methods such as spin coating method, spraying method, dipping method, blade coating method, roll coating method, and screen printing method.

In order to prevent the first recording layer 5 and the second recording layer 11 from crosstalk across them, the ultraviolet curable resin 14 is preferable to be thicker. However, if it is too thick, a problem such that spherical aberration occurs and a record mark can not be formed may happen. Consequently, it is suitable for a thickness of the ultraviolet curable resin 14 to be within a range of 10 μm to 60 μm.

Further, the ultraviolet curable resin 14 is composed of photo-initiator and monomer such as prepolymer, mono-functional acrylate monomer, and multi-functional acrylate monomer.

[Transferring Process]

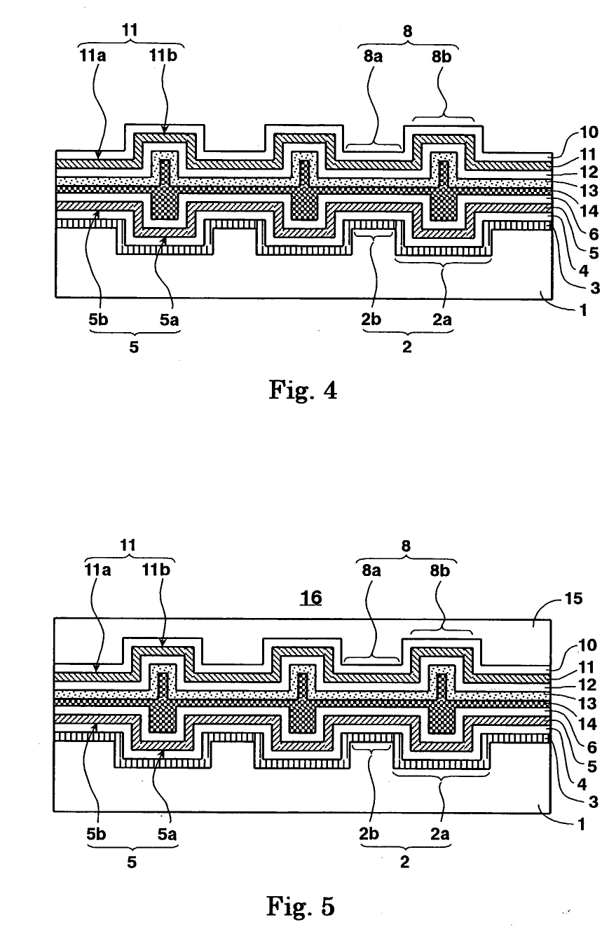

FIG. 4 is a cross sectional view of the optical disc showing a transferring process in the manufacturing method according to the embodiment of the present invention.

As shown in FIG. 4, separating the second substrate 7 together with the separative layer 9 from the laminated first substrate 1 transfers the third protective layer 10, the second recording layer 11, the fourth protective-layer 12, and the second reflective layer 13 over the first substrate 1.

Accordingly, the first substrate 1 having two layers of the first and second recording layers 5 and 11 is manufactured.

With respect to separation of the second substrate 7, actually, a knife is inserted between the separative layer 9 and the third protective layer 10, and then the second substrate 7 is separated from the third protective layer 10.

[Process of Forming Cover Layer]

FIG. 5 is a cross sectional view of the optical disc as a final product showing a process of forming a cover layer in the manufacturing method according to the embodiment of the present invention.

As shown in FIG. 5, an ultraviolet curable resin not shown is coated on the surface of the third protective layer 10. A cover layer 15 that is light transmittable and has a thickness of 0.01 mm to 0.3 mm is disposed on the ultraviolet curable resin not shown.

Further, a flat glass plate not shown is placed over the cover layer 15 and an ultraviolet ray is irradiated on the flat glass plate not shown. Then, the flat glass plate not shown is removed and a laser beam is irradiated on the cover layer 15 to initialize the first and second recording layers 5 and 11.

Accordingly, an optical disc 16 having two layers of the first and second recording layers 5 and 11 is manufactured.

As mentioned above, according to the embodiment of the present invention, transferring the second recording layer 11 over the first recording layer 5 of the first substrate 1 as the second layer forms the first and second recording layers 5 and 11 on the first substrate 1. Therefore, the optical disc 16 having two recording layers for a blu-ray can be obtained through the similar processes to the manufacturing processes of conventional DVD discs.

Further, a manufacturing process exclusively for a blu-ray disc is not necessary, so that an optical disc can be manufactured in less expensive cost and higher productivity.

Furthermore, initializing the first recording layer 5 and the second recording layer 11 can be conducted individually, so that an optimal initialization optimized for each recording layer can be performed.

Accordingly, the optical disc 16 having excellent characteristics can be manufactured.

As shown in FIG. 5 that exhibits a final product of the optical recording medium 16 manufactured in accordance with the manufacturing method of the present invention, the first recording layer 5 is disposed so as to face toward the second recording layer 11 such that the groove 5a of the first recording layer 5 faces toward the land 11b of the second recording layer 11 and the land 5b of the first recording layer 5 faces toward the groove 11a of the second recording layer 11 respectively. In other words, the recessed portion 2a of the first embossed pit 2 or the groove 5a of the first recording layer 5 is disposed so as to be symmetric with respect to the raised portion 8b of the second embossed pit 8 or the land 11b of the second recording layer 11.

Further, a pile of laminated layers of the recessed portion 2a or the groove 5a is different from that of the raised portion 8b or the land 11b, if the pile of laminated layers is observed microscopically.

Accordingly, if a pile of laminated layers of an optical disc is observed by an electron microscope, the optical disc can be identified as an optical disc 16 that is manufactured by the manufacturing method according to the present invention.

While the invention has been described above with reference to the specific embodiment thereof, it is apparent that many changes, modifications and variations in the arrangement of equipment and devices and in materials can be made without departing the invention concept disclosed herein. For example, in this embodiment of the present invention, an optical disc of which a number of recording, layers is two is explained typically. However, an optical disc having more than two recording layers can also be manufactured by the same processes as those for two recording layers.

Further, the first and second recording layers 5 and 11 are explained as a rewritable type optical disc. However, it is apparent that by changing compositions of the first and second recording layers 5 and 11, the optical disc 16 can be applied for a write once type or read only memory (ROM) type optical disc.

Furthermore, it is also acceptable that the ultraviolet curable resin 14 is coated on the surface of the second reflective layer 13 and the first substrate 1 is laminated over the ultraviolet curable resin 14 with directing the second protective layer 6 to face toward the ultraviolet curable resin 14 in reverse order from the laminating process shown in FIG. 3. Then, the ultraviolet curable resin 14 is hardened by irradiating an ultraviolet ray UV on the ultraviolet curable resin 14 through the second substrate 7.

In addition thereto, in FIGS. 3-5, the second recording layer 11 is laminated over the first recording layer 5 such that the land 11b of the second recording layer 11 faces toward the groove 5a of the first recording layer 5 or the raised portion 8b of the second embossed pit 8 faces toward the recessed portion 2a of the first embossed pit 2. However, disposing the second recording layer 11 over the first recording layer 5 is not limited to arrange as shown in FIGS. 3-5. They can be arranged at random in the horizontal direction.

It will be apparent to those skilled in the art that various modifications and variations could be made in the manufacturing method of optical disc in the present invention without departing from the scope or spirit of the invention.

What is claimed is:

1. A manufacturing method of an optical disc comprising:
a first process of forming at least a first recording layer over a first embossed pit of a first substrate;
a second process of forming at least a separative layer and a second recording layer sequentially over a second embossed pit of a second substrate having light transmittability;
a third process of laminating the second substrate over the first substrate after coating an ultraviolet curable resin over the first recording layer and facing the second recording layer toward the ultraviolet curable resin, and hardening the ultraviolet curable resin by irradiating an ultraviolet ray on the ultraviolet curable resin through the second substrate;
a fourth process of transferring the second recording layer over the first recording layer by separating the second substrate from the first substrate together with the separative layer; and
a fifth process of forming a thin cover layer having light transmittability over the second recording layer.

2. A manufacturing method of an optical disc comprising:
a first process of initializing a first recording layer after forming at least the first recording layer over a first embossed pit of a first substrate;
a second process of initializing a second recording layer after forming at least a separative layer and the second recording layer sequentially over a second embossed pit of a second substrate having light transmittability;
a third process of laminating the second substrate over the first substrate after coating an ultraviolet curable resin over the first recording layer and facing the second recording layer toward the ultraviolet curable resin, and hardening the ultraviolet curable resin by irradiating an ultraviolet ray on the ultraviolet curable resin through the second substrate;
a fourth process of transferring the second recording layer over the first recording layer by separating the second substrate from the first substrate together with the separative layer; and
a fifth process of forming a thin cover layer having light transmittability over the second recording layer.

3. An optical disc comprising:
a first substrate having a first embossed pit being formed with at least a first recording layer over the first embossed pit;
a second substrate having a second embossed pit being formed with at least a separative layer and a second recording layer sequentially laminated over the second embossed pit, and
an ultraviolet curable resin layer coated over the first recording layer and being sandwiched between the first and second substrates and cured by irradiating an ultraviolet ray, wherein the second reflective layer is faced toward the ultraviolet curable resin layer,
the optical disc is further characterized in that the second substrate is separated from the first substrate together with the separative layer, and that a thin cover layer having light transmittability is formed over the second recording layer.

4. The optical disc in accordance with claim 3, wherein the first recording layer is further initialized after the first recording layer is formed over the first embossed pit of the first substrate, and the second recording layer is initialized after the separative layer and the second recording layer is formed over the second embossed pit of the second substrate.
